(19) United States
(12) Patent Application Publication
(10) Pub. No.: US 2011/0248491 A1
(43) Pub. Date: Oct. 13, 2011

(54) BOOK STRUCTURE

(76) Inventor: Stephen Harvey STEARN, Firenze (IT)

(21) Appl. No.: 12/906,731

(22) Filed: Oct. 18, 2010

(30) Foreign Application Priority Data
Apr. 9, 2010 (IT) BO2010A000217

(51) Int. Cl. B42D 1/00

(52) U.S. Cl. 281/38

(57) ABSTRACT

A book structure includes: at least a page defining a first layer (10) provided with at least a drawing or a detachable three-dimensional element (11); a second layer (20) overlappable to the first layer (10) and provided with one or more elements (21) to be associated to the at least element (11) of the first layer (10) to complete the same element; and a third layer (30) overlappable to the second layer (20) and provided with one or more elements (31) to be associated to the elements (11, 21) provided on the first layer (10) and second layer (20) to complete the same elements.

### CROSS REFERENCE TO RELATED APPLICATIONS

This application claims the benefit of priority under 35 U.S.C. §119 of Italian Patent Application IT-No. BO2009A000217 filed Apr. 9, 2010.

### FIELD OF THE INVENTION AND BACKGROUND OF THE INVENTION

The present invention is part of publishing and it relates, in particular, to a structure of a book or of another editorial product as, for example, a children's book, an illustrated book, an atlas, etc. . . . The present structure is useful in improving the education of a young child, through the interaction of the structure of the book with the young user. According to the known state of the art, books, particularly for children, are comprised of a plurality of pages in paper, plastic-coated cardboard or plastic having a rigidity and/or a thickness which is greater than normal paper so as to allow a better handling and/or a better wear strength. In some cases, pages have a plurality of holes which, when the book is closed, are stacked to provide a kind of three-dimensionality to all the pages overlapped.

WO2009/047823 relates to a new structure of book which, starting from the known concept of overlapping holes, provides a high interaction with the book itself, increasing interest in the same, making it more easily understandable and usable according to multiple modes. In particular, the document above described shows a book structure comprised of a plurality of pages bound together and presenting a perforated shaped portion, the perforated portions of the pages being arranged to be overlapped when the corresponding pages of the book are overlapped, with the perforated portion of each page which is not smaller than the corresponding portion of the previous page and not larger than the corresponding portion of the next page.

### SUMMARY OF THE INVENTION

The present invention provides a more advanced educational tool that can increase the interaction of the young user, leading to the discovery and/or to a better knowledge of shapes, colors, words, thanks to a series of educational steps relating to subsequent or different uses of the structure of the invention.

In particular, thanks to the present invention, it is possible to provide a “progressive” approach to the knowledge of the child. As will be described further below, the editorial product structure consists of a first level or layer (which may consist of one or more pages) that includes one or more drawings and/or one or more three-dimensional elements, and a series of successive layers, overlapping the first one. The first level is comprised of essentially simple drawings (a little complex) and three-dimensional elements that can be manipulated by the child and provides to the child the concept of shape or size. In addition, the first level is with few colored portions (i.e. it is substantially black and white or it has very soft colors, or only the colors of the backgrounds). The next levels gradually add other elements to form a complete set. For example, it is possible to use a second level in which there are more colored portions and/or more complex drawings; furthermore, it is possible to use a third level in which the words which make up a story are reproduced, also using dialogues printed in balloons (comics): in this way a possible story started with the use of previous levels can be completed. In a particular embodiment, the third layer can include words (referring to pictures of previous levels) in a first language, and there is a fourth layer with the same words in another language, to integrate the mental connection between a drawing and its shape or its color with the correspondent word used in one or more languages.

For example, the second layer can add colors to the design of the first layer. This can be achieved by means of partially transparent sheets to be superimposed on the first level of the structure. It can also be achieved by adding an opaque sheet which has the both the first level graphics as well as the added second level graphics.

The combination of layers which overlap each over above described can be applied to all pages of the editorial product structure (i.e. a book) or only to some of them.

Among the advantages of the present invention are: it is possible for the child to interact with the book in a more enhanced and interesting way, especially when these are children; the structure is easily manufacturable and requires no special equipment for its manufacture, even in large quantities; the same structure can be made of different materials, not requiring the exclusive use of a particular material.

These and other advantages and features of the present invention will be more and better understood from the following description and with the attached drawings, given as practical examples of the invention, but not to be considered in a limiting sense. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic reproduction of parts of a structure according to the present invention, in which the structure is shown in one of different configurations;

FIG. 2 is a schematic reproduction of parts of a structure according to the present invention, in which the structure is shown in another of different configurations;

FIG. 3 is a schematic reproduction of parts of a structure according to the present invention, in which the structure is shown in another of different configurations;

FIG. 4 is a schematic reproduction of parts of a structure according to the present invention, in which the structure is shown in another of different configurations;

FIG. 5 is a schematic reproduction of parts of a structure according to the present invention, in which the structure is shown in another of different configurations;

FIG. 6 is a sectional view of a portion of a possible example of a structure according to the present invention;

FIG. 7A is a schematic plan view of a structure according to the present invention with FIG. 7A showing the structure in an assembled or “final” configuration;

FIG. 7B is a view of a structure according to the present invention with FIG. 7B showing the parts which comprise the same structure as FIG. 7A and which contribute to its use for teaching and educational knowledge;

FIG. 8 is a plan view of a book structure according to the invention, in which a second layer is formed by many parts like a puzzle; and

FIG. 9 is a lateral view of a book structure similar to the example of FIG. 8.

### DESCRIPTION OF A PREFERRED EMBODIMENT OF THE INVENTION

In the accompanying drawings, the structure usable for a book or another publishing product, is marked with 1 in its entirety.

Structure 1 is comprised of a plurality of pages 10 to form, in practice, a structure similar to a book.

Page 10 is provided with three-dimensional elements 11 consisting of its parts which can be detached, leaving corresponding holes 12 on page 10.

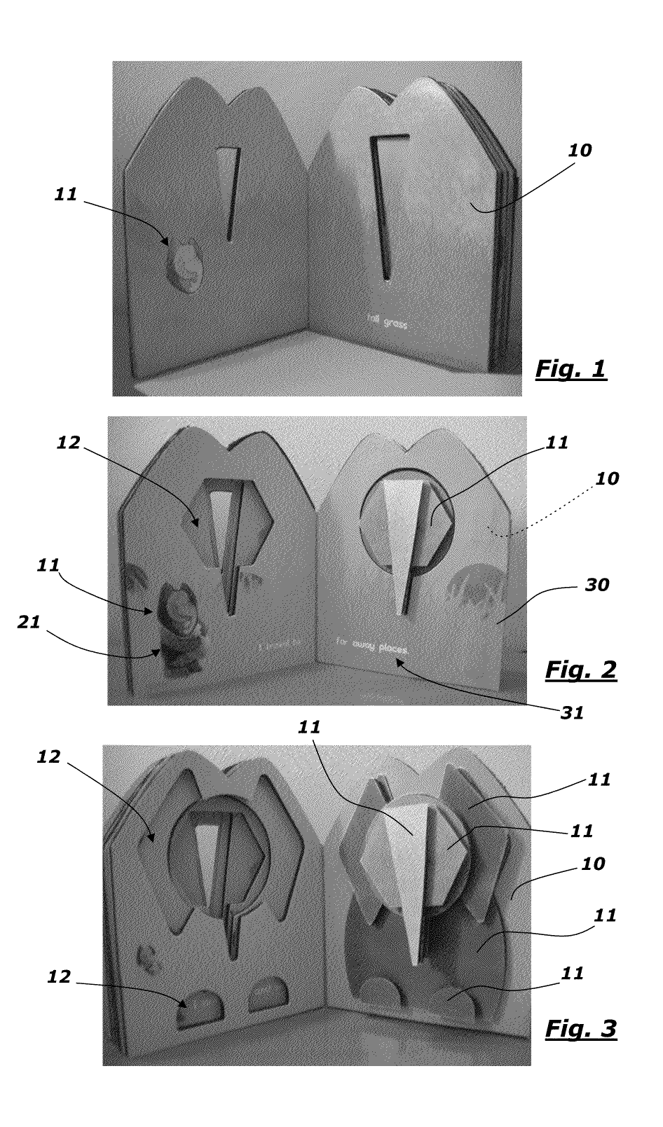

As shown in the examples of FIGS. 1-5, the three-dimensional elements 11 consist of portions of page 10 that can be detached from the same page to allow children to play with characters represented by such elements and/or invent a story.

According to the aim of the invention, this phase is the basic learning phase, in which the child knows the story characters. Also, it can improve the hand manipulation and hand coordination of the child who seeks to integrate the various elements 11 in the empty spaces of the different holes 12 left with empty spaces.

The first layer formed by page 10 may be covered with a second level or layer, marked with 20 in the drawings. The second layer 20 enhances the possibilities of the story, providing colors and increasing the sense of depth of the drawings which become more complex.

There is a third layer or level, marked with 30 in the drawings, on which are placed (i.e. printed) the words 31 that complete the story.

It is possible to provide the page with a fourth layer or level 30′ which differs from the third since the words are in a different language from the third. In the example, the third level 30 is in Italian, while the fourth 30′ is in English language.

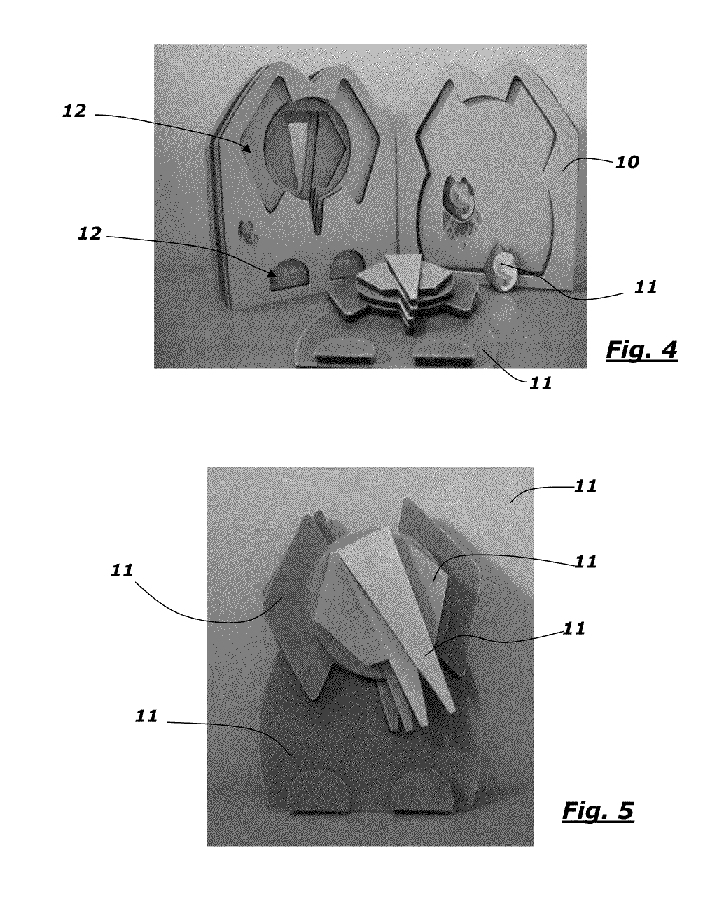

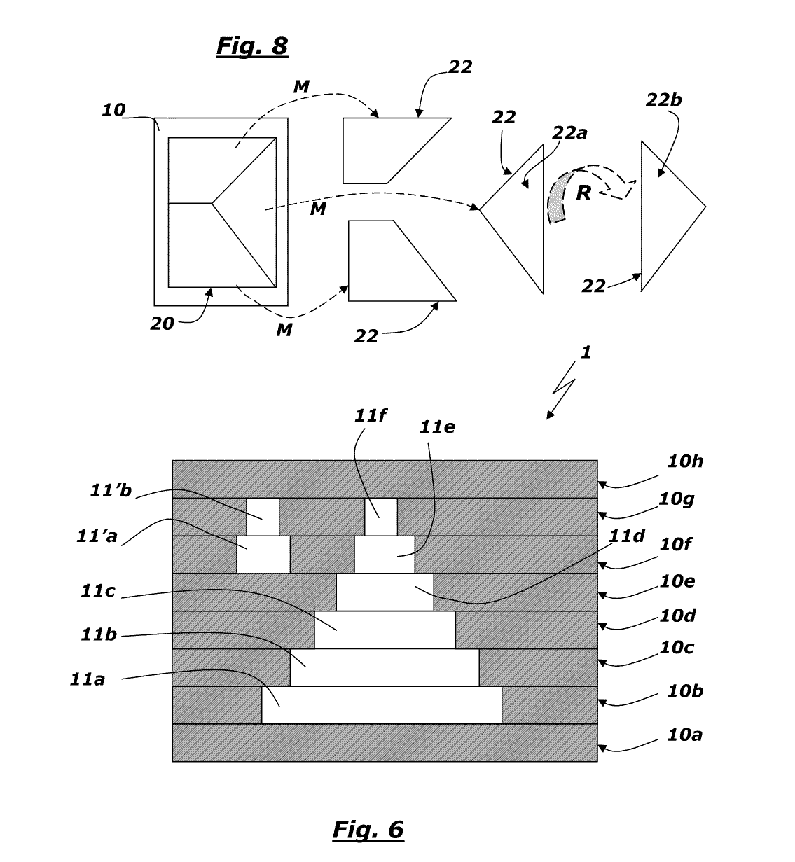

Thanks to the educational structure of the present invention, initially, the child (and perhaps an assisting care giving) has only the simple forms supplied by the first level and with the motivation these forms, invents a story, like toys, provides, invents story, possibly overlapping the three-dimensional elements, as in FIGS. 4 and 5, to form an initial interpretation of the book. In fact, the three-dimensional elements 11, once detached from the corresponding page can be stacked together to form three-dimensional elements more complex.

In addition, the child learns to recognize the shapes and to replace the elements 11 taken from the book back into the book structure.

In a simplified embodiment of the invention, the first layer can contain only a single drawing or detachable three-dimensional element which extends from the surface of the first layer.

By means of the integration of the second layer with the first, the child can also compare and alter the story he had planned with the possible locations (also real) of the characters, with the help of additional designs and colors 21.

The third layer 30 completes the story, with the help of elements 31 which contribute to a further growth of the child's ability.

Advantageously, moreover, the shaped profile of the hollow portions 12 can be a part of a pattern reproduced on the corresponding page of the same portion provided with holes, the design reproduced on each of its components being compatible with the design provided on the other pages, so as to give place to other designs combined with the other pages.

In practice, with the first layer there is an integration of manual (hand use and hand-eye development) and mental (mind or intellectual development) in the creation of a story. This story is created here with very little influence of the limited graphic representations provided and under no influence of written word descriptions or commands. As such it has a high degree of freedom in the choice of characters, their interactions, etc. . . .

The second layer provides more story guidance because of the added more complex graphics. It teaches and offers the story visual commands and comparisons with real world objects and solutions.

The third level provides the means for learning words by joining the same words 31 with the images and the characters 11 and 21 of the previous levels. It therefore can both imposes verbal commands and ideas which need to be integrated with existing stories as well as impose an official story.

It is noteworthy that the characters remain the same in all three layers of the book. This continuity of characters is extremely useful since the three levels are never completely independent of each other. The linkages between the layers as well as the separate introduction of characters, pictures and words provides new learning tools and learning motivations for the parent and child care-giver, encouraging them to both to love books and stories and learn in a better way. It is possible to introduce the concept of “motivational training” in the sense that each level is prepared for by the previous level and adds new information and understandings.

In particular embodiment of the invention, the order in which the layers are stacked can be different from that described. For example, the first layer can be firstly overlapped by the third layer and, then, by the second layer. In other words, the overlapping and the stacking of the layers can be different from the examples of the attached drawings.

According to another embodiment, a single physical piece of material, i.e. cardboard, has on one side a second layer 20 and on its other side a third layer 30. In this way, one physical piece can serve as the two layers 20 and 30 when this piece is attached or held to first page layer 10. When the piece of material is placed down on layer 10 with the third layer 30 not visible, it satisfies the second layer 20 features. When it is place on the first layer 10 with layer 20 not visible, it satisfies the third layer 30 features. In other words, it is possible to form the structure with multiple layer (20) and multiple layer 30. The above single physical piece with two layers can be attached to the basic book structure as a puzzle piece where the single piece (marked with 22 in FIG. 8) fits when either side is faced down on the page of the layer 10 into a cutout border on the book structure page. This method of puzzle piece attachment can also be used to attach or hold in place on first layer 10 any type of secondary layer 20 or third layer 30 where each is composed of its own single piece of material.

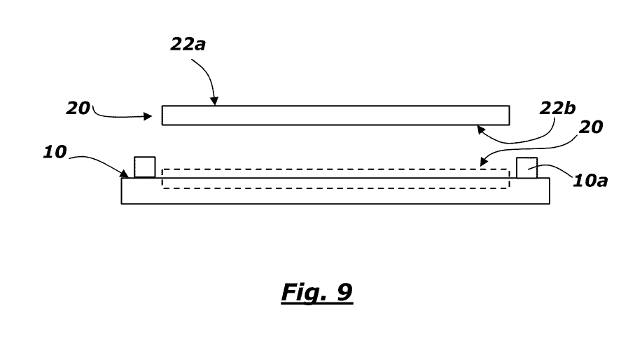

In FIGS. 8 and 9, the second layer 20 is composed of one or more pieces, which are marked with 22. The side which has the features of the second layer 20 is marked with 22a, while the other side, which has the features of the third layer 30, is marked with 22b. The page 10 of the first layer can be provided with a raised surface (marked with 10a in FIG. 9) which defines a “border” for the piece/s 22 of the second layer 20. In FIG. 8 arrows M indicate movement of the pieces, the arrow R indicates the rotation, with overturning of one of the pieces 22.

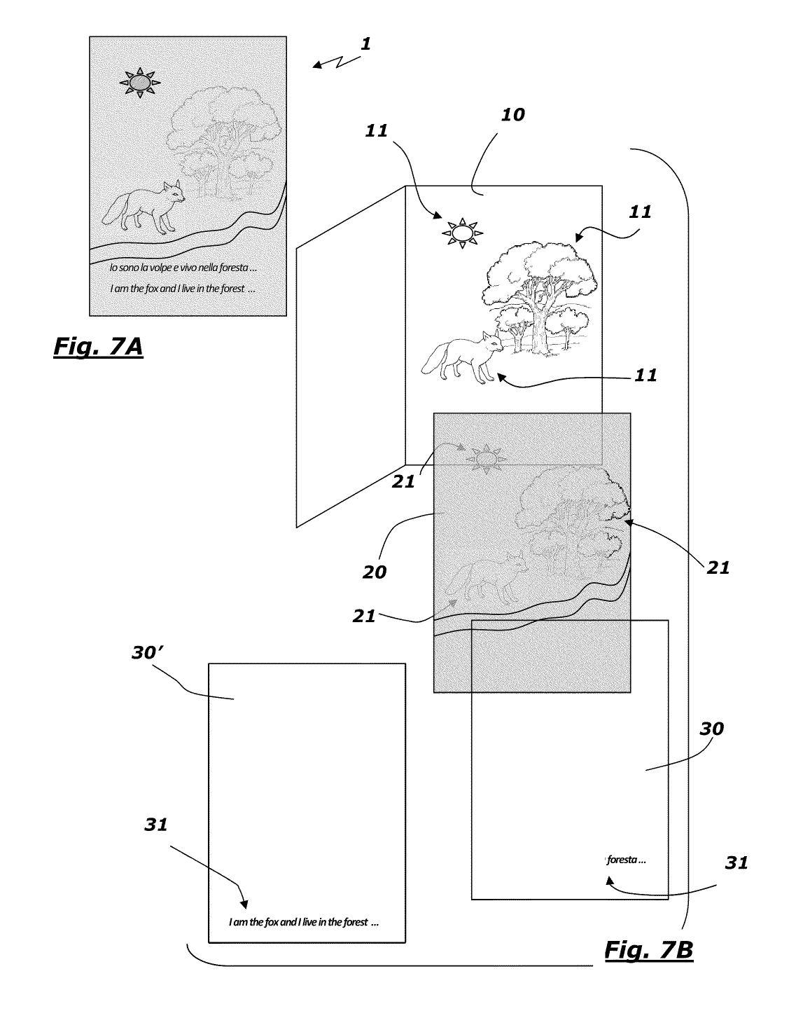

It is important to highlight that after the main sculpture is taken out of (removed from) the book, then all the pages which will receive second and third layers are flat rectangular surfaces unless it has an elevated border like the “puzzle page” shown in FIGS. 8 and 9. In practice, the sides of this page (marked by 10) can be elevated (border 10a). Furthermore, the puzzle marked with 22 in Fig can also be a single piece and this single piece can still be a “puzzle piece”. Another feature of the present invention is that the added layers can be transparent pieces or opaque pieces (non-transparent). If the main sculpture remains inside the book structure, whether permanently attached or free to be moved outside the book, then many of the added layers will have to have a hole of a certain shape in them so as to accommodate the piece of sculpture which will be elevated on the page. If the removable main sculpture is a “character” then when it is outside the book it does help to integrate the book and all of its added layers. However, if the main sculpture is a series of “geometric shapes”, then keeping this sculpture attached to the book or put back into the book, opens up many more “geometric learning” possibilities since there will also be the need to fit many added layer onto elevated sculpture pieces on the first (rectangular) page. These elevated sculpture pieces can also be turned around a central axis, this also enhances the “geometry learning”. It might also be good to mention that the “puzzle page” also enhances “geometric learning” because its elevated page border can also be shaped in irregular ways. After it has been removed, the main sculpture piece can be placed back into the book structure and that in this way the book structure also serves as a package or a holder for the main sculpture. (In this way, the main character “lives” or has “a home” inside the book) According to another embodiment of the invention, a book which comprises the book structure (as shown in FIGS. 1-6) can be associated to a CD for computer, where the CD can contain all the information supplied by the second and the third (and/or fourth) layer (such information can be represented by the elements shown in FIGS. 7A and 7b) and where the CD might also include a pictorial representation of the basic book structure as well. The product would be a physical book with physical three-dimensional elements or sculptures and a CD for computer with the graphics layers and word layers which can be added to computer pictures of the physical book structure and sculptures.

A variation of the above would be to provide a physical basic book sculpture which also has all the layers of graphics and words above described and which can sell together with a CD computer version of the same book where the basic book and layers can be separated and used independently on the computer screen.

Another variation would be to have a complete book with graphics and words together (which would be a regular finished sculpture book with no layering) which can be associated along with a CD computer version where the user can separate the basic book from the layers on the computer and add layers to the basic book using the computer.

Moreover, the execution details may equally vary as regards shape, size, disposition of elements, kind of material used, within the limits of the solution idea that has been adopted and within the limits of the present invention.

While specific embodiments of the invention have been described in detail to illustrate the application of the principles of the invention, it will be understood that the invention may be embodied otherwise without departing from such principles.

1. A book structure comprising:
at least a page defining a first layer provided with at least a drawing or a detachable three-dimensional element;
a second layer overlappable to the first layer and provided with one or more elements to be associated to said at least element of the first layer to complete the same element;
a third layer overlappable to the second layer and provided with one or more elements to be associated to the elements provided on the first layer and second layer to complete the same elements.

2. The structure of claim 1, wherein the first layer is printed of black and white or light colors, the second layer is in color, the third layer is provided with words.

3. The structure of claim 2, wherein the third layer is provided with words in a language and that there is a fourth level provided with words in a different language.

4. The structure of claim 1, wherein:
the structure is formed by a plurality of pages joined together and presenting at least one perforated portion with shaped profile, the hollow portions of those pages being arranged to be overlapped when the corresponding pages of the structure are overlapped;
the hollow portion of each page is not smaller than the corresponding hollow portion of the previous page and not larger than the corresponding hollow portion of the next page; and
the structure is provided with a plurality of overlapped laminar elements, which correspond to the number of overlapping pages and have a thickness substantially corresponding to the thickness of those pages.

5. The structure of claim 1, wherein the three-dimensional elements, once detached from the corresponding page can be stacked together to form complex three-dimensional elements.

6. The structure of claim 1, wherein the contour of said hollow portions is a part of a pattern reproduced on the corresponding page provided with the same hollow portion, the drawing reproduced on each of said elements being compatible with the drawing provided on the other pages, so as to form other drawings combined with other pages.

7. The structure of claim 1, wherein a single physical piece of material has on one side said second layer and on its other side said third layer.

8. The structure of claim 1, wherein the second layer comprises two or more pieces forming puzzle.

9. The structure of claim 7, wherein the second layer comprises two or more pieces forming puzzle.

10. The structure of claim 1, wherein comprises a CD for computer containing all the information supplied by the second layer and/or the third layer.
